(19) United States
(12) Patent Application Publication
(10) Pub. No.: US 2006/0118061 A1
(43) Pub. Date: Jun. 8, 2006

(54) Bag spool rewind assembly

(76) Inventor: Timothy Edwards, Del Mar, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/006,957

(22) Filed: Dec. 7, 2004

(51) Int. Cl. A01K 27/00

(52) U.S. Cl. 119/795

(57) ABSTRACT

A dispenser for bags wound about an axle includes a housing having a base and defining an inner cavity in which the bags are disposed. A wheel is disposed between the base and the bags. The wheel engages the axle and is rotatable relative to the housing. A portion of the wheel extends through the housing to be exteriorly accessible. Rotation of the bags within the inner cavity of the housing may be directly effected by manipulation of the portion of the wheel extending through the housing.

### BACKGROUND OF THE INVENTION

The present invention relates in general to devices for collecting animal litter. More particularly, the present invention relates to a dispenser of bags for collecting animal litter.

The rapid increase of urban population coupled with the increasing popularity of dogs and other pets has created a serious sanitary problem in connection with the disposal of animal litter, and particular canine litter. Because many animal pet owners have permitted their animals to deposit solid excrement on both private and public property, a number of communities have enacted ordinances requiring pet owners, under penalty of fine, to retrieve and dispose of lifter created by their pets.

It has been found that the willingness of pet owners to retrieve and properly dispose of animal litter is related to the ease, convenience and economy with which the litter may be handled in a clean and sanitary manner. While a number of devices have been proposed for the purpose of disposing of animal litter, they have suffered from various shortcomings. Some devices are not completely disposable and, therefore, require some degree of cleanup. Other types of devices, both of the disposable and reusable varieties, are awkward and/or conspicuous to carry. Moreover, some prior animal lifter collection devices are too expensive for everyday use.

One commonly accepted method for collecting and storing animal litter until a proper disposal site can be found involves the use of a disposable plastic bag. Some pet owners will simply place a plastic bag, such as a plastic grocery bag, in a clothing pocket for retrieval when needed. This method of collecting animal lifter presupposes, however, that the pet owner will always have access to and remember to grab a plastic bag prior to walking the pet. There have been proposals to provide devices which would store plastic bags within a container that may be worn by the owner or the pet. Each of these prior devices, however, suffers several disadvantages which the present invention is intended to overcome.

The retractable leash has been gaining popularity for the last twenty years and has taken its place as a permanent pet product. Some have recognized the desirability of providing an easy way to carry pet waste cleanup bags when going for a walk utilizing such a retractable leash. For example, U.S. Pat. No. 5,540,469 discloses a retractable leash placed into an animal waste collecting device which incorporates its own handle, bag holder and flashlight. It is believed, however, that such an assembly involves apparatus and associated costs which are undesirable.

Accordingly, there is a need for a bag dispenser which provides access to bags when needed. There is a further need for a bag dispenser which provides access to a roll of plastic bags when needed. There is an additional need for a bag dispenser which provides easier manipulation of the bags when accessing the bags. There is also a need for a bag dispenser that allows the roll of bags to be rotated both clockwise and counterclockwise. The present invention fulfills these needs and provides other related advantages.

### SUMMARY OF THE INVENTION

The present invention discloses a bag dispenser which provides access to bags when needed. The present invention further discloses a bag dispenser which provides access to a roll of plastic bags when needed. The present invention additionally discloses a bag dispenser which provides easier of manipulation of the bags when accessing the bags. The present invention also discloses a bag dispenser that allows the roll of bags to be rotated both clockwise and counterclockwise. The bag dispenser provides bags for a variety of purposes including, without limitation, the collection of animal waste.

A dispenser for bags wound about an axle includes a housing having a base and defining an inner cavity in which the bags are disposed. A wheel is disposed between the base and the bags. The wheel engages the axle and is rotatable relative to the housing. The wheel includes an axle guide that extends into the axle.

A portion of the wheel extends through a slot in the housing to be exteriorly accessible. Rotation of the bags within the inner cavity of the housing may be directly effected by manipulation of the portion of the wheel extending through the housing. The axle is rotatable relative to the lid. The axle and wheel are removably connected. The base of the housing includes means for rotatably supporting the wheel on the base. In this manner, the axle is rotatable relative to both the lid and the base of the housing.

A removable lid for enclosing an open end of the housing. The lid snap-fits to the open end of the housing and the lid positions the wound bags centrally within the inner cavity as the bags rotate within the housing. The lid includes a connector that attaches the dispenser to a leash.

The housing includes an aperture through which the bags are individually removable from the inner cavity.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of a bag dispenser embodying the present invention;

FIG. 2 is an exploded, cut-away front perspective view of the bag dispenser of FIG. 1 illustrating the interior of the bag dispenser;

FIG. 3 is a side elevational view of the bag dispenser of FIG. 1;

FIG. 4 is an exploded, cut-away front perspective view of the bag dispenser of FIG. 1 illustrating the interior of the bag dispenser, the lid, axle and roll of bags;

FIG. 5 is an inverted perspective view of the lid and axle of the bag assembly of FIG. 1; and

FIG. 6 is a cross-sectional elevational view of the bag dispenser of FIG. 1, taken along line 6-6 of FIG. 3, illustrating the rotation of the axle.

### DETAILED DESCRIPTION OF THE PREFERRED EMBODIMENT

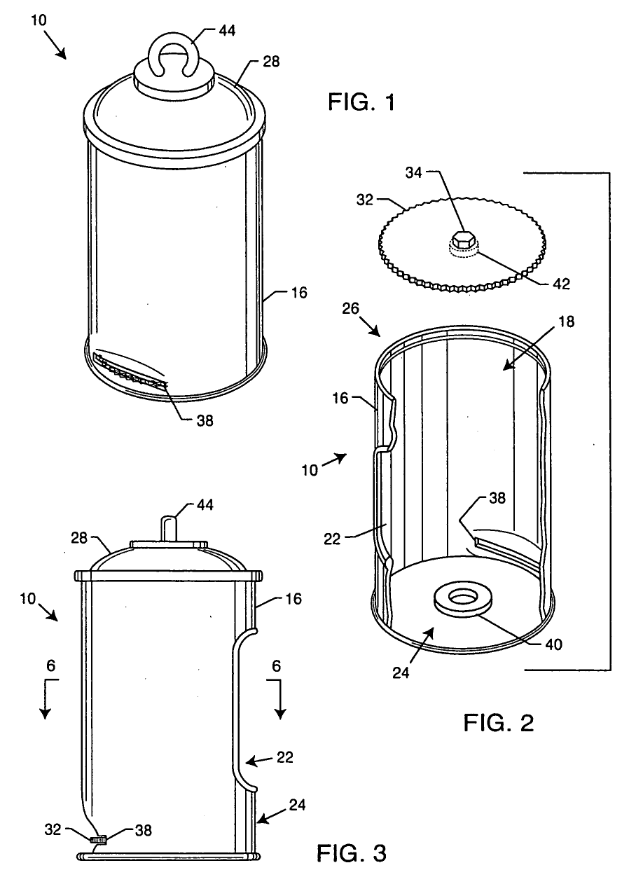

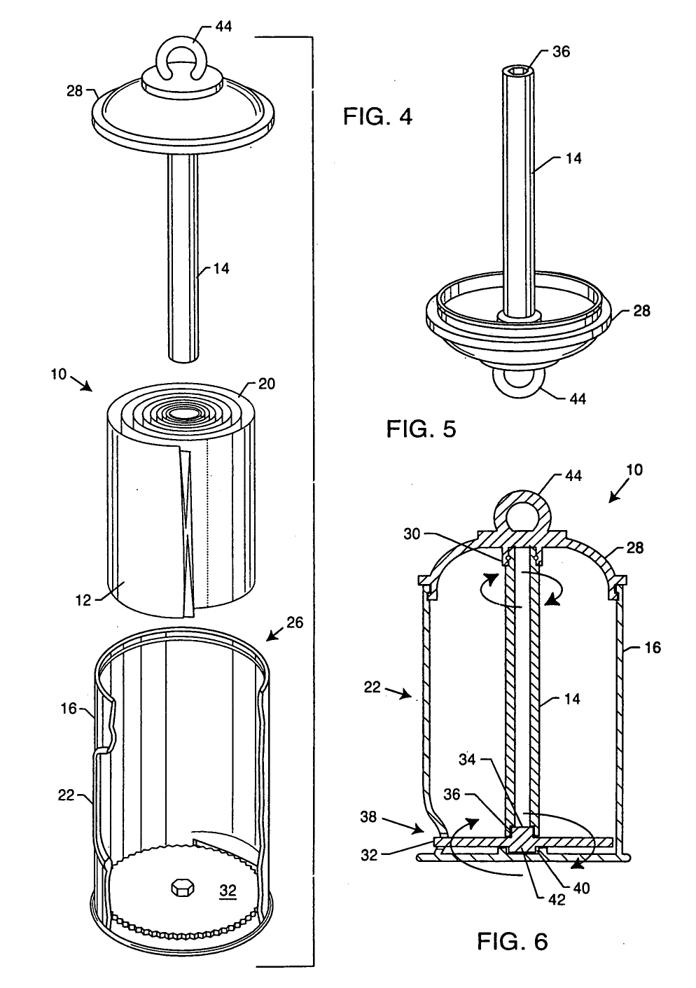

As shown in FIGS. 1-6 for purposes of illustration, the present invention resides in a bag dispenser 10 for bags 12 wound about an axle 14. The bag dispenser 10 includes a housing 16 which defines an inner cavity 18 for holding therein a roll 20 of a plurality of plastic bags 12 which are connected end-to-end. The roll 20 of plastic bags 12 is disposed within the inner cavity 18 of the housing 16 such that the bags 12 may be individually removed therefrom through an aperture 22 in the housing 16.

The bag dispenser 10 is generally cylindrical in shape and includes the aperture 22 provided in a side wall of the housing 16. The housing 16 includes a cylindrical base 24 which has an open upper end 26 through which the roll 20 of plastic bags 12 may be inserted into and disposed within the inner cavity 18. A removable lid 28 encloses the upper open end 26 of the cylindrical base 24. As shown, the lid 28 snap-fits onto the open upper end 26 of the cylindrical base 24 of the housing 16.

The bag dispenser 10 further includes means for centrally and rotationally retaining the roll 20 of plastic bags 12 within the housing 16. This retaining means includes the tubular axle 14 about which the roll 20 of plastic bags 12 is wound, and means for positioning the axle 14 centrally within the inner cavity 18 of the housing 16 such that the tubular axle 14, and thus the roll 20 of plastic bags 12, may rotate therein. More specifically, the axle positioning means comprises an upper axle guide 30 which is integrally formed with the lid 28 and extends downwardly therefrom into the inner cavity 18.

The axle 14 is rotatable relative to the lid 28. An upper end of the axle 24 is snap-fit insertable into the upper axle guide 30 which retains the axle 14 therein even as the axle 14 rotates in place while the lid 28 remains stationary.

The bag dispenser 10 also includes a wheel 32 disposed between the base 24 and the roll 20 of bags 12. The wheel 32 engages the axle 14 and is rotatable relative to the housing 16. The axle 14 and wheel 32 are removably connected. The wheel 32 includes an upper axle guide rod 34 that extends into a lower portion 36 of the axle 14. The axle guide rod 34 is shaped to conform with the shape of the interior of the lower portion 36 of the axle 14. For example, the axle guide rod 34 is hexagonally shaped (FIG. 1) to match the hexagonal shape of the interior of the axle (FIGS. 5 and 6) and sized so as to be frictionally retained therein. This results in the axle 14 rotating in the same direction as the wheel 32 when the wheel 32 is rotated by a user as the rotating axle guide rod 34 engages the interior of the axle 14. The wheel 32 also prevents movement of the roll 20 of bags 12 past the lower end of the axle 14 and contact with the base 24.

A portion of the wheel 32 extends through a slot 38 in the housing 16 and is exteriorly accessible. As the diameter of the cylindrical housing 16 is generally greater than that of the wheel 32, the slot 38 is positioned towards the bottom of the base 24 of the housing 16 and is recessed from the side wall of the housing 16 in order to accommodate the smaller diameter of the wheel 32 relative to the housing 16. Rotation of the bags 12 within the inner cavity 18 of the housing 16 is directly effected by manipulation of the portion of the wheel 32 extending through the housing 16. The circumference of the wheel is sawtooth shaped so as to increase a user's grip for turning the wheel 32 by finger(s).

The base 24 of the housing 16 includes means for rotatably supporting the wheel 32 on the base 24 in the form of a ring-shaped mount or lower wheel axle guide 40 extending upwardly from the base 24 and upon which the wheel 32 rests. The wheel 32 includes a lower axle guide rod 42 that extends into the interior of the lower wheel axle guide 40. The axle guide rod 42 is shaped to conform with the shape of the interior of the lower wheel axle guide 40. For example, the axle guide rod 42 is generally cylindrical (FIG. 6) to match the circular shape of the interior of the lower wheel axle guide 40 (FIGS. 2 and 6). This results in the wheel 32 being held in place in the center of the housing 16 as the wheel 32 is rotated by a user and engages the axle 14, causing the axle 14 to rotate with the wheel 32. There is sufficient space between the axle guide rod 42 and the wheel axle guide 40 to allow the wheel 32 to rotate without undue frictional contact between the sides of the axle guide rod 42 and the wheel axle guide 40. In this manner, the axle 14 is rotatable relative to both the lid 28 and the base 24 of the housing 16 as the ends of the axle 14 are securely yet rotatably retained centrally within the inner cavity 18.

In use, fifteen or so plastic bags 12 are wound about the axle 14 to form the roll 20. Alternatively, a replacement roll 20 may include bags 12 pre-wound about an axle 14 which replaces the axle 14 from the previous roll 20. Eitherway, the lid 28 is removed from the cylindrical base 24 to place the new roll 20 within the inner cavity 18. The upper end of the tubular axle 14 is fitted into the upper axle guide 30 and secured into position. When the lid 28 is replaced over the open upper end 26 of the cylindrical base 24 and snap-fit into place, the lower end of the axle 14 engages the upper axle guide rod 34 of the wheel 32. In the alternative, the wheel 32 may be connected to the axle 14 prior to the lid 28 being replaced on the housing 16. The end bag 12 of the roll 20 may then be accessed through the housing aperture 22 and withdrawn from the housing 16 as desired. The entire roll 20 of plastic bags 12 disposed on the axle 14 will rotate within the housing 16 as the bags 12 are withdrawn therefrom. The bags 12 are preferably releasably attached to one another such that one bag 12 may be easily separated from another after being withdrawn from the dispenser 10, yet the bags 12 are sufficiently attached to one another to prevent such separation as they are being withdrawn from the dispenser.

The bag dispenser 10 is intended to be utilized in connection with a collar, harness or a leash device (not shown) commonly utilized when walking one's pet. The bag dispenser 10 may also be attached to a key chain (not shown) or the like. The leash device may be simple leather or chain leash or a leash device that incorporates a retractable leash that extends from a housing.

The lid 28 of the bag dispenser 10 includes an upper eye loop 44 integrally formed with the lid 28 and extending outwardly therefrom for connecting the bag dispenser 10 to a leash device. A ring (not shown), bead tie (not shown) or the like is placed through the loop 44 to securely affix the dispenser 10 to the leash device or the like.

Although an embodiment has been described in detail for purposes of illustration, various modifications may be made without departing from the scope and spirit of the invention.

What is claimed is:

1. A dispenser for bags wound about an axle, comprising:
a housing having a base and defining an inner cavity in which the bags are disposed; and
a wheel disposed between the base and the bags, the wheel including means for engaging the axle and being rotatable relative to the housing; wherein a portion of the wheel extends through the housing to be exteriorly accessible;
wherein rotation of the bags within the inner cavity of the housing may be directly effected by manipulation of the portion of the wheel extending through the housing.

2. The dispenser of claim 1, wherein the housing includes a slot through which the portion of the wheel extends.

3. The dispenser of claim 1, including a removable lid for enclosing an open end of the housing.

4. The dispenser of claim 3, wherein the lid positions the wound bags centrally within the inner cavity as the bags rotate within the housing, the axle being rotatable relative to the lid.

5. The bag dispenser of claim 3, wherein the lid includes means for connecting the dispenser to a leash.

6. The bag dispenser of claim 3, wherein the lid snap-fits to the open end of the housing.

7. The bag dispenser of claim 1, wherein the axle and wheel are removably connected.

8. The bag dispenser of claim 1, wherein the engaging means comprises an axle guide extending into the axle.

9. The bag dispenser of claim 1, wherein the base includes means for rotatably supporting the wheel.

10. The bag dispenser of claim 1, wherein the housing includes an aperture through which the bags are individually removable from the inner cavity.

11. A dispenser for bags wound about an axle, comprising:
a housing having a base and defining an inner cavity in which the bags are disposed; and
a wheel disposed between the base and the bags, the wheel including means for engaging the axle having an axle guide extending into the axle, the wheel being rotatable relative to the housing; wherein a portion of the wheel extends through a slot in the housing to be exteriorly accessible;
wherein rotation of the bags within the inner cavity of the housing may be directly effected by manipulation of the portion of the wheel extending through the housing.

12. The bag dispenser of claim 1 1, wherein the axle and wheel are removably connected.

13. The bag dispenser of claim 11, wherein the base includes means for rotatably supporting the wheel.

14. The bag dispenser of claim 11, wherein the housing includes an aperture through which the bags are individually removable from the inner cavity.

15. The dispenser of claim 11, including a removable lid for enclosing an open end of the housing.

16. The dispenser of claim 15, wherein the lid positions the wound bags centrally within the inner cavity as the bags rotate within the housing, the axle being rotatable relative to the lid.

17. The bag dispenser of claim 15, wherein the lid includes means for connecting the dispenser to a leash.

18. The bag dispenser of claim 15, wherein the lid snap-fits to the open end of the housing.

19. A dispenser for bags wound about an axle, comprising:
a housing having a base and defining an inner cavity in which the bags are disposed;
a wheel disposed between the base and the bags, the wheel including means for engaging the axle and being rotatable relative to the housing; wherein a portion of the wheel extends through a slot of the housing to be exteriorly accessible; and
a removable lid for enclosing an open end of the housing;
wherein rotation of the bags within the inner cavity of the housing may be directly effected by manipulation of the portion of the wheel extending through the housing; wherein the lid positions the wound bags centrally within the inner cavity as the bags rotate within the housing, the axle being rotatable relative to the lid; and wherein the housing includes an aperture through which the bags are individually removable from the inner cavity.

20. The bag dispenser of claim 19, wherein the lid includes means for connecting the dispenser to a leash.

21. The bag dispenser of claim 19, wherein the lid snap-fits to the open end of the housing.

22. The bag dispenser of claim 19, wherein the axle and wheel are removably connected; and the engaging means comprises an axle guide extending into the axle.

23. The bag dispenser of claim 19, wherein the base includes means for rotatably supporting the wheel.
